(19) United States
(12) Patent Application Publication
(10) Pub. No.: US 2002/0116522 A1
(43) Pub. Date: Aug. 22, 2002

(54) Network congestion control in a mixed traffic environment

(75) Inventor: David Zelig, Givatayi (IL)

Correspondence Address: DARBY & DARBY P.C., 805 Third Avenue, New York, NY, 10022, US

(73) Assignee: ORCKIT COMMUNICATIONS LTD.

(21) Appl. No.: 09/791,018

(22) Filed: Feb. 22, 2001

(51) Int. Cl. G06F 15/16

(52) U.S. Cl. 709/235

(57) ABSTRACT

A method for managing a buffer includes receiving a stream of data fragments into the buffer, at least some of the fragments being arranged in packets, each such packet comprising a last fragment. While a fill level of the buffer remains below a first threshold, the received fragments are accepted into the buffer. When the fill level of the buffer increases above the first threshold, the buffer continues to accept the received fragments until the last fragment in one of the packets is received or until the fill level of the buffer increases above a second threshold, greater than the first threshold. When the last fragment in one of the packets is received, the fragments that are received thereafter are discarded until the last fragment in another, subsequent one of the packets is received and the fill level of the buffer is no longer above the first threshold. The buffer then continues to accept the received fragments. When the fill level of the buffer increases above the second threshold, the fragments that are received thereafter are discarded until the fill level of the buffer decreases below a third threshold, no greater than the second threshold. The buffer then continues to accept the received fragments, regardless of whether the last fragment in any of the packets is received.

### FIELD OF THE INVENTION

The present invention relates generally to communication networks and systems, and specifically to congestion control and recovery mechanisms used in communication networks.

### BACKGROUND OF THE INVENTION

In Asynchronous Transfer Mode (ATM) networks, data are carried over virtual circuits in the form of cells, each 53 bytes long. The ATM protocol layer works on a hop-by-hop basis and is responsible for switching the cells. Higher protocol layers, such as an Internet Protocol (IP) layer, may be used to transmit data packets over the ATM network. Other higher-level protocols are used to transmit non-packet data, such as native voice data. A number of different ATM adaptation layers (AALs) are defined by ATM standards in order to provide end-to-end service for different types of higher-level packet and non-packet protocols over the ATM layer.

Because of the small, fixed size of the ATM cells, data packets transmitted over an ATM network are usually fragmented into a number of cells. The appropriate AAL, typically AAL3/4 or AAL 5, is responsible for segmentation and reassembly (SAR) of the packets-breaking up the packet into cells at the transmission source, and rebuilding the packet from the cells received at the destination. The last cell in each packet is marked with a special bit in the ATM header, which enables the AAL at the receiving end to recognize the end of the packet. No reassembly can take place until all of the cells in the packet have arrived, and if any of the cells does not arrive, the entire packet is discarded.

When a network becomes congested, buffers may overflow, leading to loss of data. In order for the network to provide good performance even in the case of congestion, the data must be discarded in a controlled way, following a defined congestion control policy. The policy is typically designed in such a way as to enhance network performance. For ATM networks, the different service categories and applicable traffic management and congestion control functions are described in Traffic Management Specification Version 4.1, promulgated by the ATM Forum Technical Committee (document AF-TM-0121.000, March, 1999), which is incorporated herein by reference.

In order to deal optimally with network congestion when packet data are concerned, ATM switches should preferably discard entire packets, rather than just individual cells. The reason for this preference is that even if only a single cell is discarded from a given packet, the entire packet becomes unusable and cannot be reassembled. Thus, in the absence of an orderly packet-oriented cell discard policy, the loss of network data carrying capability is usually much greater than the number of cells that are actually discarded. For this reason, the above-mentioned ATM Traffic Management Specification (section 5.8, page 43) provides for the possibility of discard at the frame level (i.e., the packet level), but only for connections for which frame discard is specifically enabled, either via signaling or at subscription time.

Although ATM specifications do not prescribe any particular frame discard mechanism, a variety of different packet discard policies have been proposed and implemented. Labrador and Banerjee survey such policies in an article entitled “Packet Dropping Policies for ATM and IP Networks,” in IEEE Communications Surveys 2(3), pages 2-14 (1999), which is incorporated herein by reference. For certain types of packet traffic, such as TCP/IP packets, a combination of methods known as partial packet discard (PPD) and early packet discard (EPD) has been found to be particularly efficient. Two buffer thresholds are established for this purpose: an EPD threshold and a PPD threshold. The PPD threshold is always set higher than the EPD threshold. When a given buffer passes its EPD threshold level, it enters an EPD standby state until it has sent the last cell of the current packet. At the end of the packet, if the buffer is still over the EPD threshold, it enters an EPD discard state. In this state, all subsequent packets are dropped in their entirety until the buffer fill has dropped back below the EPD threshold. PPD is used as a last resort, when the buffer fill level rises too high and immediate discard is required. In this case, cell discard may begin in the middle of a packet, and continues until the last cell in the current packet is received. The buffer then returns to the EPD discard state, in which whole frames are discarded, as described above.

The PPD/EPD method assumes that all connections to which it is applied are packet-type connections. The standard AAL5 header field of the cells is sufficient to identify the last cell in each packet. On the other hand, non-packet traffic does not carry any end-of-packet identification. Therefore, if both packet and non-packet traffic are carried on the same connection, and the buffer enters the PPD state during a non-packet transmission, cell discard can continue indefinitely while waiting in vain for a cell that will signal the end of a packet. This type of cell discard behavior is entirely unacceptable for high-priority, non-packet services, such as voice. In conventional ATM systems, this infinite discard problem is avoided by requiring that the service type of a connection (packet or non-packet) be declared in advance, as noted above. In practice, however, network service providers cannot always know in advance whether a connection is to be used for packet or non-packet traffic.

### SUMMARY OF THE INVENTION

It is an object of the present invention to provide improved methods and devices for network traffic management and congestion control.

It is a further object of some aspects of the present invention to provide a multi-threshold data discard policy that can operate satisfactorily on both packet and non-packet data.

In preferred embodiments of the present invention, a congestion control policy in a cell-oriented network provides early discard of packet data when a buffer level rises above a predetermined EPD threshold, and discard of both packet and non-packet data when the buffer level rises above a higher, maximum fill threshold. After the buffer level has passed the maximum fill threshold, general cell discard (including both packet and non-packet data) continues until the buffer level has dropped back below a given resumption threshold. At this point, the general cell discard stops, regardless of whether or not the last cell of a packet has arrived. The policy thus allows various types of traffic to be carried over the same connection, with the benefit of EPD for managing packet traffic congestion, while avoiding the problem of infinite cell discard of non-packet traffic that is encountered in EPD/PPD systems known in the art.

Various resumption thresholds may be selected. In one preferred embodiment, the resumption threshold is set equal to the maximum fill threshold. This embodiment allows simple implementation of the present invention in mixed packet/non-packet data environments. In another preferred embodiment, the resumption threshold is set equal to the EPD threshold, and the buffer returns to a normal operating state (non-EPD) when the buffer level has dropped below this level. The lower resumption threshold level in this embodiment provides a hysteresis, so that the buffer does not toggle rapidly back and forth between discarding and retaining cells. Neither of these methods significantly compromises performance in terms of packet data throughput relative to conventional EPD/PPD policies. The second of the two methods (in which the resumption threshold is set equal to the EPD threshold) has been found to give slightly better performance when most of the traffic is packet traffic. Other choices of resumption threshold levels will be apparent to those skilled in the art.

There is therefore provided, in accordance with a preferred embodiment of the present invention, a method for managing a buffer, including:

receiving a stream of data fragments into the buffer, at least some of the fragments being arranged in packets, each such packet including a last fragment;

while a fill level of the buffer remains below a first threshold, accepting the received fragments into the buffer;

when the fill level of the buffer increases above the first threshold, continuing to accept the received fragments into the buffer until the last fragment in one of the packets is received or until the fill level of the buffer increases above a second threshold, greater than the first threshold;

when the last fragment in one of the packets is received, discarding the fragments that are received thereafter until the last fragment in another, subsequent one of the packets is received and the fill level of the buffer is no longer above the first threshold, and then continuing to accept the received fragments into the buffer; and

when the fill level of the buffer increases above the second threshold, discarding the fragments that are received thereafter until the fill level of the buffer decreases below a third threshold, no greater than the second threshold, and then continuing to accept the received fragments into the buffer, regardless of whether the last fragment in any of the packets is received.

In a preferred embodiment, receiving the stream of data fragments includes receiving cells for transmission over an Asynchronous Transfer Mode (ATM) network, for example, exchanging data with a network subscriber via a connection to a Digital Subscriber Line Access Multiplexer.

Typically, the stream of data fragments also includes data that are not arranged in packets, wherein the last fragment of each packet contains an indication that it is the last fragment in the packet, and wherein the fragments that include the data that are not arranged in packets do not contain such an indication. In a preferred embodiment, receiving the stream of data fragments includes receiving non-packetized native voice data.

Preferably, accepting the received fragments includes passing the fragments to a network switching element for transmission over the network.

In a preferred embodiment, the third threshold is substantially equal to the first threshold.

In another preferred embodiment, the third threshold is substantially equal to the second threshold. Preferably, continuing to accept the received fragments after the fill level of the buffer decreases below the third threshold includes continuing to accept the received fragments into the buffer until the last fragment in one of the packets is received or until the fill level of the buffer increases again above the second threshold.

There is also provided, in accordance with a preferred embodiment of the present invention, communications apparatus, including:

a buffer, coupled to receive and store a stream of data fragments for transmission over a network, at least some of the fragments being arranged in packets, each such packet including a last fragment; and

a buffer controller, adapted to control the buffer in accordance with the methods described herein.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a network access multiplexing system, in accordance with a preferred embodiment of the present invention;

FIG. 2 is a flow chart that schematically illustrates a method for network congestion control, in accordance with a preferred embodiment of the present invention; and

FIG. 3 is a flow chart that schematically illustrates a method for network congestion control, in accordance with another preferred embodiment of the present invention.

### DETAILED DESCRIPTION OF PREFERRED EMBODIMENTS

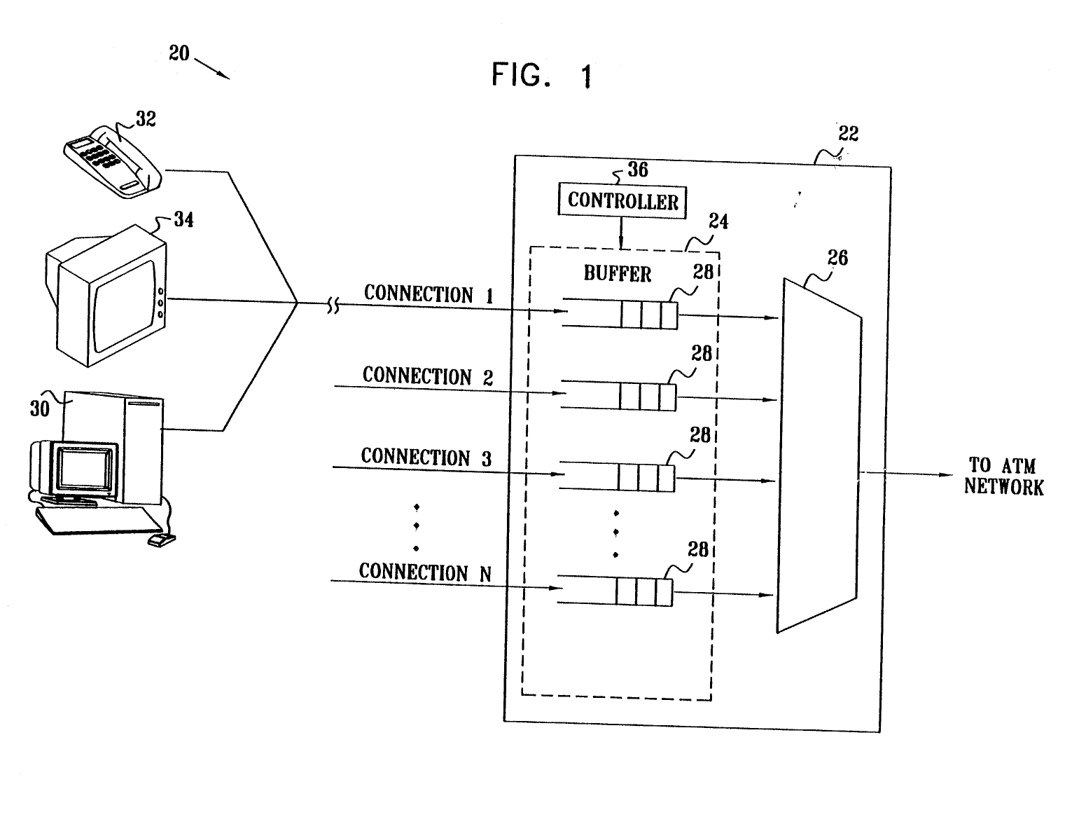

FIG. 1 is a block diagram that schematically illustrates a network access multiplexing system 20, in accordance with a preferred embodiment of the present invention. System 20 provides ATM network services to multiple subscribers, via switching equipment 22. In the embodiment shown in FIG. 1, the switching equipment comprises a Digital Subscriber Line Access Multiplexer (DSLAM). This embodiment is described here solely for the purpose of illustration, however, and the principles of the present invention may similarly be implemented in network switches and equipment of other types.

Equipment 22 comprises a buffer 24 and a multiplexer 26. The equipment serves multiple subscriber connections, labeled connections 1 through N. Each of the connections feeds a respective queue 28 in the buffer, where the data are held in the form of cells for transmission over the ATM network. For the sake of simplicity, only these limited elements of the equipment are shown and described here. The remaining components needed to assemble a working DSLAM or other switching equipment will be apparent to those skilled in the art. Although only a single buffer 24 is shown in the figure, it will be appreciated that actual network switching equipment typically includes multiple buffers of different types and levels. The methods of congestion control described herein may be applied to substantially all such buffers. Furthermore, each subscriber connected to the equipment may feed multiple queues, corresponding to different network service categories and priorities, rather than only a single queue 28 as shown in the figure.

The subscriber connections of equipment 22 may carry multiple data types, including both packet data, to and from a computer 30, for example, and non-packet data, such as native voice to and from a telephone 32 and digital video to or from video equipment 34. The type of data to be carried by a given connection is not necessarily known in advance. Therefore, it is not known in advance whether the data on a particular ATM connection (known in the art as an ATM virtual connection) will be packet oriented or non-packet oriented. When one of the queues begins to fill up, or when the entire buffer begins to fill up, equipment 22 begins to discard cells from the queues in accordance with a congestion control policy that is described hereinbelow. These buffer management functions are preferably carried out by a suitable buffer controller 36 in equipment 22, such as the Siemens PXB 4330E ATM Buffer Manager (ABM) chip set. The operation of the ABM is described in Application Note 11.98, published by Siemens AG (Munich, Germany), which is incorporated herein by reference.

The congestion control methods described hereinbelow are preferably carried out separately for all ATM virtual connections that shares the same buffers. While the buffer occupancy and thresholds are the same for all of these ATM connections, the congestion control state for each connection may be different, as the type of traffic may be different for each active ATM connection.

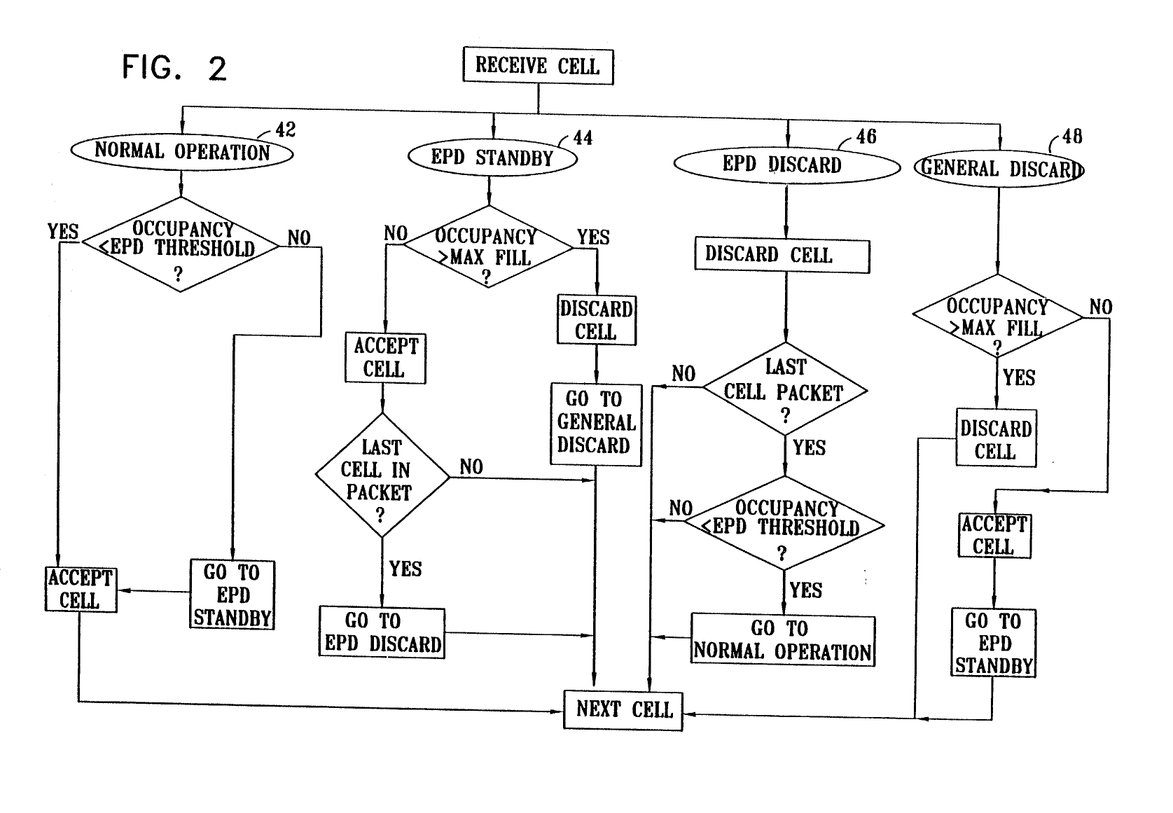

FIG. 2 is a flow chart that schematically illustrates a method for congestion control for use in system 20, in accordance with a preferred embodiment of the present invention. The method is applicable both to individual queues 28 and to buffer 24 as a whole, as well as to other buffers (not shown) in system 20. The term “buffer” is used hereinbelow to refer to any buffer or queue in the system to which the method may be applied. In preparation for carrying out this method, buffer controller 36 is programmed with an appropriate EPD threshold and a maximum fill threshold, depending on the buffer size, service category, available data bandwidth and other traffic considerations. The maximum fill threshold must be set greater than the EPD threshold. When a device such as the above-mentioned Siemens ABM (which has programmable EPD and PPD thresholds) is used to carry put the functions of buffer controller 36, the PPD threshold value is set to the desired maximum fill threshold. The ABM is reprogrammed, however, so that when the buffer fill surpasses this upper threshold, its treatment of the buffer is modified, as described below. The programming is preferably carried out by appropriately setting flags in the registers of the ABM.

As long as the buffer fill stays below the EPD threshold, the buffer remains in a normal operation state 42, and every cell is accepted, i.e., passed to memory in buffer 24 while waiting to be drawn out by multiplexer 26. If the total occupancy of the buffer, while in the normal operation state, exceeds the EPD threshold, the current cell is accepted, but the buffer transfers to an EPD standby state 44.

While in EPD standby state 44, the buffer continues to pass cells to memory until the last cell in a packet is encountered. At this point, the last cell is accepted and, as long as the buffer is still above the EPD threshold, the buffer transfers to an EPD discard state 46. If the given connection is carrying non-packet traffic, the buffer will remain in EPD standby state 44 until the buffer occupancy rises above the maximum fill threshold. At this point the buffer discards the current cell and transfer to general discard state 48.

While in EPD discard state 46, cells are discarded until the last cell in a packet is reached, and the buffer occupancy has dropped back below the EPD threshold. The buffer then returns to normal operation state 42. As long as a given connection is carrying non-packet traffic, it will not reach EPD discard state 46, since it may enter this state only when a cell with an end-of-packet mark appears, which is not possible for this kind of connection. Therefore, there will be no problem of infinite cell discard as may occur in the PPD state of conventional systems.

In general discard state 48, all cells are discarded for as long as the buffer occupancy remains above the maximum fill threshold. Once the occupancy drops below this level, the current cell is accepted, and the buffer transfers back to EPD standby state 44. Since the buffer exits the general discard state without waiting for the last cell in a packet, the problem of infinite discard of non-packet cells is avoided. It may occur, however, that the buffer toggles back rapidly between EPD standby state 44 and general discard state 48.

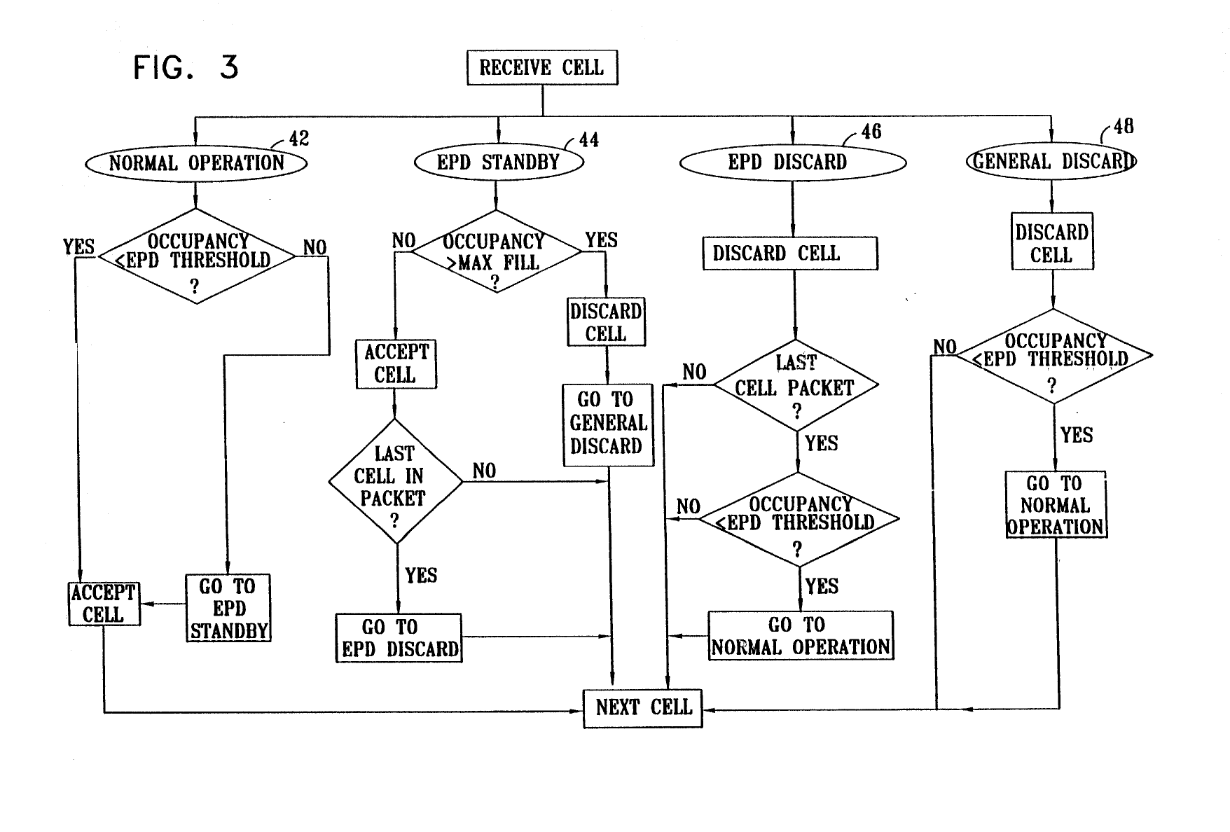

FIG. 3 is a flow chart that schematically illustrates another method for congestion control, in accordance with an alternative preferred embodiment of the present invention. This method is substantially similar to the method of FIG. 2, except for the behavior of the buffer in general discard state 48. In the embodiment of FIG. 3, when the buffer is in the general discard state, all cells are discarded until the buffer occupancy has dropped below the EPD threshold. At this point, the buffer returns to normal operation state 42. The use of the EPD threshold as the exit point from the general discard state introduces a hysteresis, so that the buffer is thoroughly “cleaned out” before exiting the general discard state. As a result, the toggling that may be encountered while using the method of FIG. 2 is avoided. The above-mentioned Siemens ABM is not well suited for carrying out this method, but other devices known in the art may be used instead, such as the Condor device produced by Tioga Technologies Inc., of San Jose, Calif. Aspects of this device are described in U.S. patent application Ser. No. 09/443,157, filed Nov. 18, 1999, which is assigned to the assignee of the present patent application and whose disclosure is incorporated herein by reference.

Although preferred embodiments are described herein with reference to ATM networks, and specifically to transmission of IP packets over such networks, the principles of the present invention are similarly applicable, mutatis mutandis, to networks of other types that carry both packet and non-packet data, and in which packet fragmentation and reassembly are used. Therefore, in the context of the present patent application and in the claims, the term “packet” should be understood as referring to datagrams of substantially any type, while “cells” refers generally to fragments of any sort into which the data (packet or non-packet) are divided for transmission through the network.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as, well as variations and modifications thereof which would occur to persons skilled in the art upon reading the foregoing description and which are not disclosed in the prior art.

1. A method for managing a buffer, comprising:
receiving a stream of data fragments into the buffer, at least some of the fragments being arranged in packets, each such packet comprising a last fragment;
while a fill level of the buffer remains below a first threshold, accepting the received fragments into the buffer;
when the fill level of the buffer increases above the first threshold, continuing to accept the received fragments into the buffer until the last fragment in one of the packets is received or until the fill level of the buffer increases above a second threshold, greater than the first threshold;
when the last fragment in one of the packets is received, discarding the fragments that are received thereafter until the last fragment in another, subsequent one of the packets is received and the fill level of the buffer is no longer above the first threshold, and then continuing to accept the received fragments into the buffer; and
when the fill level of the buffer increases above the second threshold, discarding the fragments that are received thereafter until the fill level of the buffer decreases below a third threshold, no greater than the second threshold, and then continuing to accept the received fragments into the buffer, regardless of whether the last fragment in any of the packets is received.

2. A method according to claim 1, wherein receiving the stream of data fragments comprises receiving cells for transmission over an Asynchronous Transfer Mode (ATM) network.

3. A method according to claim 2, wherein receiving the stream of data fragments comprises exchanging data with a network subscriber via a connection to a Digital Subscriber Line Access Multiplexer.

4. A method according to claim 1, wherein the stream of data fragments also comprises data that are not arranged in packets.

5. A method according to claim 4, wherein the last fragment of each packet contains an indication that it is the last fragment in the packet, and wherein the fragments that comprise the data that are not arranged in packets do not contain such an indication.

6. A method according to claim 4, wherein receiving the stream of data fragments comprises receiving non-packetized native voice data.

7. A method according to claim 1, wherein accepting the received fragments comprises passing the fragments to a network switching element for transmission over the network.

8. A method according to claim 1, wherein the third threshold is substantially equal to the first threshold.

9. A method according to claim 1, wherein the third threshold is substantially equal to the second threshold.

10. A method according to claim 9, wherein continuing to accept the received fragments after the fill level of the buffer decreases below the third threshold comprises continuing to accept the received fragments into the buffer until the last fragment in one of the packets is received or until the fill level of the buffer increases again above the second threshold.

11. Communications apparatus, comprising:
a buffer, coupled to receive and store a stream of data fragments for transmission over a network, at least some of the fragments being arranged in packets, each such packet comprising a last fragment; and
a buffer controller, adapted to control the buffer, such that while a fill level of the buffer remains below a first threshold, the received fragments are accepted into the buffer, and
when the fill level of the buffer increases above the first threshold, the received fragments continue to be accepted into the buffer until the last fragment in one of the packets is received or until the fill level of the buffer increases above a second threshold, greater than the first threshold, and
when the last fragment in one of the packets is received, the fragments that are received thereafter are discarded until the last fragment in another, subsequent one of the packets is received and the fill level of the buffer is no longer above the first threshold, after which the received fragments are accepted into the buffer, and
when the fill level of the buffer increases above the second threshold, the fragments that are received thereafter are discarded until the fill level of the buffer decreases below a third threshold, no greater than the second threshold, after which the received fragments are accepted into the buffer, regardless of whether the last fragment in any of the packets is received.

12. Apparatus according to claim 11, wherein the stream of data fragments comprises cells for transmission over an Asynchronous Transfer Mode (ATM) network.

13. Apparatus according to claim 12, wherein the apparatus comprises a Digital Subscriber Line Access Multiplexer, coupled to exchange the data fragments over a network connection with a subscriber.

14. Apparatus according to claim 11, wherein the stream of data fragments also comprises data that are not arranged in packets.

15. Apparatus according to claim 14, wherein the last fragment of each packet contains an indication that it is the last fragment in the packet, and wherein the fragments that comprise the data that are not arranged in packets do not contain such an indication.

16. Apparatus according to claim 14, wherein the data that are not arranged in packets comprise native voice data.

17. Apparatus according to claim 11, wherein the buffer is coupled to pass the accepted fragments to a network switching element for transmission over the network.

18. Apparatus according to claim 11, wherein the third threshold is substantially equal to the first threshold.

19. Apparatus according to claim 11, wherein the third threshold is substantially equal to the second threshold.

20. Apparatus according to claim 19, wherein after the fill level of the buffer decreases below the third threshold, the buffer controller causes the buffer to accept the received fragments until the last fragment in one of the packets is received or until the fill level of the buffer increases again above the second threshold.
